(19) United States
(12) Patent Application Publication
(10) Pub. No.: US 2024/0313702 A1
(43) Pub. Date: Sep. 19, 2024

(54) SYSTEM AND PROCESS FOR THE TARGETED SIMULTANEOUS USE OF SOLAR RADIATION TO GENERATE ELECTRICITY AND TO HEAT A LIQUID CIRCUIT

(71) Applicant: SolteQ GmbH, Oberlangen (DE)

(72) Inventor: Berkay BAYER, Oberlangen (DE)

(73) Assignee: SolteQ GmbH, Oberlangen (DE)

(21) Appl. No.: 18/604,587

(22) Filed: Mar. 14, 2024

(30) Foreign Application Priority Data
Mar. 15, 2023 (DE) 102023001003.0
May 31, 2023 (DE) 102023114194.5

(51) Int. Cl. H02S 40/44; F24S 10/30; H02S 20/23

(52) U.S. Cl. CPC H02S 40/44; F24S 10/30; H02S 20/23

(57) ABSTRACT

A system and process for targeted simultaneous use of solar radiation to generate electricity, heat a liquid circuit, and reduce the heating of a building. The system uses the thermal energy in heated air. At least one solar cell module, together with at least one further element, forms a cavity on a rear side of the at least one solar cell module. Air is in the cavity and solar radiation incident on the at least one solar cell module heats the air in the cavity beneath solar shingles. The air heated is brought into contact with an air-liquid heat exchanger which is part of a liquid circuit designed for heating a refrigerant circuit, particularly a heat pump, and/or for heating an evaporator, particularly a heat pump, and/or a buffer storage tank, particularly a water-filled buffer storage.

### TECHNICAL FIELD

The invention relates to a system and process for targeted simultaneous use of solar radiation to generate electricity and to heat a fluid circuit and to reduce the heating of a building.

### BACKGROUND ART

A process is known from publications by the applicant to extract heated air in a cavity between the solar cells and the underlay membrane and to feed it to a first side of a heat exchanger of a heat pump, the other side of which is in contact with the coolant of the compressor circuit of the heat pump. A process is also known from WO 2020/229686 A2 in which the air is not conducted between the solar cell and the underlay membrane, but in a box or duct arranged under the solar cell.

### SUMMARY OF THE INVENTION

A house roof contains thermal energy from the sun. During the day, the surface of the roof is heated by solar radiation. This heat can be utilized by extracting the heated air via a tube integrated into the ridge of the roof and using it. This warm air can be fed to a heat pump, which then concentrates it and can heat the house.

The object of the invention is in particular to enable a more efficient and simpler, in particular also more locally flexible utilization of the thermal energy in the heated air, in particular without requiring large quantities of refrigerant and/or enabling a space-saving implementation in the roof area.

This invention relates, among other things, to the heat exchanger component that is required for the operation of a heat pump integrated into the ridge of the roof. The air under the solar shingles that is heated by the solar energy and thus contains thermal energy, is advantageously extracted and/or conveyed through the heat exchanger.

The thermal energy transferred and/or converted to the liquid can be transported over long distances in a simple, space-saving and maintenance-free manner and/or stored in a simple way in a buffer storage tank, in particular a buffer storage tank filled with water. The heat is preferably fed into a heat pump at least part of the time.

This principle, in particular the extraction of thermal energy via the tube in the ridge, is suitable for both new roofs and for roof renovation.

The roof, and therefore also the air under the solar shingles, is heated by the solar radiation. Each shingle is, in particular, ventilated from the rear. Fresh air is preferably admitted through the shingles and/or via the eaves. The warm air can be drawn in via the preferably recessed ridge tube and directed to the heat pump.

The object is achieved on the one hand by a system for generating electricity and heat by means of solar radiation in which at least one solar cell module together with at least one further element forms a cavity on the rear side of the at least one solar cell module with air being contained in the cavity, said system being set up in such a way that solar radiation incident on the at least one solar cell module heats the air in the cavity that is located in particular under an outer roof membrane. The system is thereby designed to bring the air heated in the cavity into contact with an air-liquid heat exchanger, said air-liquid heat exchanger being located in the ridge of a roof, in particular a pitched roof, and/or in the upper part of an air-filled cavity designed to be heated by solar radiation, with said air-liquid heat exchanger being part of a liquid circuit and/or a water line. The water line is in particular a water line leading to and/or for connecting to a tapping point and/or a service water line, in particular designed and/or arranged for supplying service and/or drinking water and/or a water line carrying service and/or drinking water. The liquid circuit is designed and/or arranged in particular for heating a refrigerant circuit, in particular a heat pump, and/or for heating an evaporator, in particular a heat pump, and/or a buffer storage tank, in particular a water-filled buffer storage tank. The liquid circuit has in particular a further heat exchanger, in particular a liquid-liquid heat exchanger and/or liquid-gas heat exchanger, designed and/or arranged for heating a refrigerant circuit, in particular a heat pump, and/or for heating an evaporator, in particular a heat pump, and/or a buffer storage tank, in particular a water-filled buffer storage tank. The liquid circuit is filled in particular with liquid. The system comprises in particular the buffer storage tank, the refrigerant circuit, the heat pump and/or the evaporator and/or the water line and/or the tapping point.

The object is also achieved by a ridge and/or top-tube air-liquid heat exchanger, formed by at least one tube, in particular a plurality of interconnected tubes, with said at least one tube, also liquid transport tube, being surrounded by fins made of metal, in particular with said tubes being surrounded by fins made of metal and the tubes being arranged parallel to one another and in particular being hydraulically coupled to one another by means of elbows, said at least one tube and the fins being arranged in a collector tube or extension tube for connection to and/or fastened to a collector tube with the same longitudinal direction as the extension and/or collector tube. The collector tube is in particular a ridge tube and/or a top tube and/or the ridge air-liquid heat exchanger is located in the ridge of a roof, in particular a pitched roof, and/or in the upper part of a cavity filled with air and in particular designed for heating by solar radiation. In particular, the ridge air-liquid heat exchanger spans at least 70% of the cross-section of the extension tube and/or collector tube and/or essentially the whole cross-section of the extension tube and/or collector tube. With particular advantage, the heat exchanger and/or the ridge air-liquid heat exchanger has a fan, in particular designed and/or arranged to supply in particular heated and/or collected air to the air-liquid heat exchanger and/or through it. The collector tube advantageously has a plurality of openings in its wall and/or at least one, in particular at least two, elongated openings in its wall. The openings are distributed in particular along the length of the collector tube. The at least one tube is advantageously arranged in a section, in particular an end section, of the extension tube and/or collector tube without openings in the wall, in which in particular the fan is also located. In particular, the section without openings in the wall is shorter than one-third of the length of the collector tube. In particular, the extension tube and collector tube are arranged coaxially and/or directly adjacent to each other and/or are both arranged as a ridge tube and/or have the same cross-section and/or the cross-sectional area of the section and/or of the extension tube is larger than the collector tube or its section with opening(s) in the wall.

The object is also achieved by processes for co-generation of electricity and heated liquid, in particular water, by solar radiation on a surface by means of at least one solar cell module forming the surface and, in particular simultaneous, heating of air below the solar cell module by the solar radiation on the surface and transfer of the thermal energy stored in the air at least partially into a liquid circuit filled with liquid and/or a water line filled with water by means of an air-liquid heat exchanger, in which in particular a heat accumulator or pool is heated or a refrigerant circuit of a heat pump is heated by means of a further heat exchanger in the liquid circuit. Preferably, in particular by means of a further heat exchanger in the liquid circuit, a heat accumulator is heated and/or a refrigerant circuit, in particular an evaporator of a heat pump, is heated, whereby the heat pump heats a further liquid and is operated in particular with the electricity from the at least one solar cell module. Preferably, a pump in the liquid circuit and/or the water line and/or for supplying drinking and/or service water, in particular heated by means of the air-liquid heat exchanger, to a tapping point is operated with the electricity from the at least one solar cell module. Preferably, drinking and/or service water heated by means of the water line and/or the heat accumulator, in particular by means of the air-liquid heat exchanger, is supplied to a tapping point.

This means that a small refrigerant circuit can be used in any location and the heat from, for example, the roof, the façade or from outside the building, can be fed from the air-liquid heat exchanger into the refrigerant circuit. This can reduce static requirements and make the use of space more flexible. A buffer storage tank and/or a heating circuit can also be directly heated. In addition, the routing of the heated air can be simplified and/or shortened and the thermal energy can generally be better utilized.

The at least one solar cell module is in particular at least 20 solar cell modules and/or at least one solar shingle.

The cavity does not have to be, and is advantageously not, completely closed in order to allow air to flow in, in particular on the side of the solar cell modules and/or the solar radiation. The cavity is generally and advantageously completely or totally closed on the side facing away from the solar radiation and/or from the solar cell module, whereby complete airtightness is generally not important. It is also preferably and essentially completely or totally closed on two opposite, at least partially vertically extending end faces, whereby complete airtightness is generally not important. It preferably has air inlet openings on the lower end face and/or on the side facing the sun or on the side on which the at least one solar cell module is arranged. The cavity is preferably significantly longer in two spatial directions than in a third, in particular perpendicular, direction. The third direction is oriented in particular roughly, in particular with a deviation of less than 30°, in the direction of the solar radiation and/or roughly, in particular with a deviation of less than 30°, in the direction perpendicular to the planar extension of the at least one solar cell module. This is particularly advantageous for heating. The direction of the solar radiation is thereby considered in particular at midday on any given day. For heat generation it is particularly advantageous to consider the direction of the solar radiation on any day in winter, in particular at midday.

The cavity is in particular predominantly filled with air, in particular it is predominantly or completely formed between the roof battens. This enables particularly effective and easy heating.

The heating can, in particular with non-transparent and preferably dark, i.e. in particular gray, blue, red and/or particularly preferably black, solar cell modules or their solar cells, be effected at least partially indirectly through the solar cell modules. However, transparent modules can also be used, especially if the rear side of the cavity is dark, i.e. in particular gray, blue or black. At least part of the heating can also be achieved by irradiation of the solar radiation into the cavity. For this, the solar cell modules have a greater transparency, particularly in a spectral range not used for power generation, than in a spectral range used for power generation.

The rear side of the solar cell module is in particular the side facing away from the sunlight in the intended installation direction and/or in the installed state.

Contact can be achieved by the air-liquid heat exchanger already being arranged in the cavity and/or by the heated air being guided to the air-liquid heat exchanger and/or past the air-liquid heat exchanger by thermal means and/or by conveying means. A circuit is also conceivable in which the air is then fed back into the cavity and/or circulates (is circulated) in the cavity. Depending on the design, existing power and heat requirements and/or weather conditions, it may be advantageous to operate a circuit or to supply fresh air. The supply of fresh/cooler air can increase the efficiency of the solar cells power generation, whereas a circuit can increase the temperature of the air. Mixed forms are also conceivable. It can therefore be advantageous to control the routing of the air and/or the amount of exhaust air from and/or supply air into the cavity. This can be achieved, for example, by controlling baffles and/or valves and/or fans. It may also be advantageous to change or control the ratio of the exhaust air from the cavity that is routed past the air-liquid heat exchanger to the exhaust air that is not routed past it. This is because bypassing is generally associated with increased flow resistances, so that larger exhaust air volumes or exhaust air volumes with a lower power consumption for fans can generally be achieved if the exhaust air is not routed through or past the air-liquid heat exchanger. The system advantageously has the appropriate means and a control system set up accordingly. An increased exhaust air volume can also reduce the heating of a building interior located below/behind the cavity. It is therefore preferable if the system is set up and/or operated in such a way that higher exhaust air volumes are realized when excess heat is drawn from the air-liquid heat exchanger and/or when no heat is to be drawn from the air-liquid heat exchanger and/or the volume of exhaust air that is not conducted past the air-liquid heat exchanger is increased. This can be achieved by appropriate control of fans and/or air routing devices such as valves and/or baffles.

Routing the air past the air-liquid heat exchanger means in particular that the air is routed past the air-liquid heat exchanger in such a way that the air and the air-liquid heat exchanger can exchange heat and/or a flow resistance is created by the air being routed past the air-liquid heat exchanger.

An X-Y heat exchanger is to be understood in particular as a heat exchanger that is not only suitable for but also intended to transfer heat from the medium X to the medium Y. In particular, it is specially designed for exchanging heat between medium X and medium Y. In particular it has at least one first surface that is intended to be brought into contact with the medium X, and at least one second surface that is intended to be brought into contact with the medium Y, with said at least one first surface and said at least one second surface being thermally coupled and in particular having a small distance between them. In particular, the system is designed and/or the process is controlled in such a way that the surface area of the at least one first surface is larger than the boundary of the medium X upstream of the heat exchanger, in particular by at least 400%. In particular, the system is designed and/or the process is controlled in such a way that the surface area of the at least one second surface is larger than the boundary of the medium Y upstream and/or downstream of the heat exchanger, in particular by at least 400%. The surface area considerations are carried out in particular with respect to a line section of the same length, said length being assumed in particular in the direction of flow, whereby in particular in the case of parallel routing and/or connection in series, the surface areas of the parallel routing are to be added together.

In particular, the first and second surfaces are made of metal, in particular aluminum and/or copper and/or similarly thermally conductive materials.

The warm air flows in particular through the heat exchanger. For example, the thermal energy can be transferred from the warm air to the liquid by means of at least one integrated tube, also known as a liquid transport tube, made of copper or other material.

Advantageously, the refrigerant circuit, the evaporator, the heat pump, the further heat exchanger and/or the buffer storage tank are arranged at a distance from the cavity and/or the air-liquid heat exchanger, in particular inside the thermal shell, in a basement, first floor and/or utility room of a building outside its thermal shell, on the façade, roof or in the outdoor facilities of which the cavity is located. This allows the advantages of the invention to be exploited particularly well. In particular, large and therefore heavy buffer storage tanks can be installed there in warm indoor rooms without static problems and without excessive heat losses from the building shell. In particular with such an embodiment, the liquid circuit is thermally insulated, i.e. in particular the tubes for connecting the air-liquid heat exchanger, also transport tubes, and the further heat exchanger are surrounded by thermal insulation, at least in particular those that convey liquid from the air-liquid heat exchanger to the further heat exchanger.

The buffer storage tank is filled in particular with water. The water can also contain additives such as anti-corrosion agents. Phase change media can also be located in the buffer storage tank, in particular surrounded by water, in order to increase its thermal capacity. The buffer storage tank has a volume of more than 500, preferably more than 1500 liters. The buffer storage tank is preferably surrounded by a thermal insulation layer.

The thermal difference between the refrigerant circuit, in particular its evaporator branch or its evaporator, and the liquid circuit can also be advantageously used to generate electrical energy using the Seebeck effect. In this way, the thermal potential can initially be used to generate electricity (i.e. in particular before the refrigerant and/or the liquid flows past the additional heat exchanger) and the somewhat lower thermal potential downstream can be reduced by the additional heat exchanger. The system is preferably configured accordingly.

Advantageously, the liquid circuit is a liquid circuit without compressor and/or the liquid circuit is not a refrigerant circuit and/or a liquid circuit without expansion device.

The liquid of the liquid circuit is advantageously one that has a boiling point above 50° C., in particular above 80° C., under standard conditions and/or the liquid circuit is a liquid circuit with a pressure below 3 bar, in particular below 2 bar and/or the liquid contains antifreeze and/or the liquid circuit is a liquid circuit which, apart from a pump arranged therein, has a cross-sectional variation of less than 20% of the maximum cross-section of the volume carrying the liquid and/or with a constant cross-section of the volume carrying the liquid and/or the liquid circuit is a liquid circuit with a pump and/or the liquid is formed by water or by water with additives, for example antifreeze and/or corrosion inhibitor, and/or contains such. In particular, the pressure in the liquid circuit is essentially dependent solely on the gravitational pressure of the liquid in the liquid circuit acting on the liquid. In particular, the liquid in the liquid circuit is pumped round the liquid circuit, in particular without being compressed or expanded. In particular, only liquid and no gas is circulated in the liquid circuit.

Such an embodiment and/or process control achieves a particularly efficient design, which is also not dependent on refrigerant in the, possibly large, liquid circuit. Heat can thus also be introduced into a buffer storage tank without the use of refrigerant. It is particularly preferable if, depending on the temperature in the liquid circuit and/or in the buffer storage tank, a refrigerant circuit is heated which directly or indirectly heats the buffer storage tank or if the buffer storage tank is heated directly. This means, for example, that the heat pump can be dispensed with completely in the summer and/or in transitional periods and the buffer storage tank can be heated directly by the liquid circuit, for example to produce hot service water or heat for heating purposes. This can also be sufficient on sunny days in winter, especially if only low inlet temperatures are required. The heating circuit, for example a panel heating system, can also be heated directly by means of the liquid circuit or the heating circuit can be integrated into the liquid circuit. In this way, heat losses at the other heat exchanger can be avoided. In particular, a first and a second further heat exchanger is/are provided, a first one in particular intended to heat a refrigerant circuit, in particular a heat pump and/or to heat an evaporator, and a second one intended to heat a buffer storage tank and/or a heating circuit, in particular a panel heating circuit.

Direct heating of the heating circuit and/or the buffer storage tank is carried out in particular if and/or as long as the temperature of the liquid exceeds a predetermined temperature which is in particular a few degrees above, in particular a number of degrees above (for example in the range of 1 to 10° C. above), the predetermined target temperature of the buffer storage tank and/or the inlet temperature of the heating circuit and/or if the temperature of the buffer storage tank and/or the inlet 10 temperature is below, in particular a few degrees (for example in the range of 1 to 10° C.) below, the temperature of the liquid circuit. The temperature of the liquid circuit is in particular a temperature of the liquid after passing the air-liquid heat exchanger and before passing the further heat exchanger and/or before heating a refrigerant circuit, a buffer storage tank and/or before entering and/or heating a heating circuit. With particular advantage, the system has an appropriately configured control system.

Advantageously, a collecting device, in particular a collector tube, for air from the cavity is arranged in, at and/or above and/or at the upper end of the cavity and/or heated air is collected in, at and/or above the cavity. In particular, the system is designed and/or the process is controlled in such a way that collected air is supplied to the air-liquid heat exchanger. This can be done by means of thermal energy and/or supported and/or effected by a fan. By collecting the air, the air heat exchanger can be made more compact and the air masses can be directed in a targeted manner. The air can be collected, for example, by means of a collector tube and/or guide devices such as metal sheets. The higher up inside the cavity this takes place, the better the heat and/or thermal energy can be utilized in most embodiments. However, other requirements may make compromises with regard to the configuration appear advantageous.

The system preferably has a condensation and/or defrost water drain, in particular in the area of the air-liquid heat exchanger and/or in the ridge tube and/or the collecting device, and/or condensation and/or defrost water accumulating on the air-liquid heat exchanger is drained, in particular from the cavity and/or air-conducting tubes connected to it. This makes it possible to achieve continuous operation without disruption due to liquid accumulation, moisture damage and/or mold formation.

Advantageously, depending on the embodiment, the further heat exchanger of the liquid circuit can also be part of a refrigerant circuit of a heat pump, and/or the system is in particular designed and/or the process is in particular controlled to supply the heat generated by the heat pump using the heat of the liquid of the liquid circuit to a buffer storage tank or the buffer storage tank, and/or to supply the heat directly to the buffer storage tank and/or a heating circuit, e.g. panel heating system. The further heat exchanger can be part of a refrigerant circuit, for example, if it is set up and arranged so that refrigerant flows through it and/or past it in order to absorb heat from the liquid by means of the further heat exchanger. For example, the evaporator of a refrigerant circuit and/or the tubes downstream of it can be heated. As a rule, the gas or liquid-gas mixture produced in the evaporator by expansion is thus heated, in particular before it is (re)compressed in order to supply heat to a downstream device, such as a buffer storage tank and/or heating circuit, before it is evaporated again in the evaporator. Such an embodiment allows the advantages of the invention to be achieved in a particularly practical and simple manner.

A heat exchanger, in particular an air-liquid heat exchanger, designed in the form of and/or within a tube, in particular an extension tube and/or collector tube, with integrated tube(s), also liquid transport tube(s), through which liquid flows or in a cassette with integrated tube(s), also liquid transport tube(s), through which liquid flows, is particularly advantageous. The tube(s) can be with or without additional fins for better heat absorption or other attachments for better heat absorption. Integration with tube(s) with or without fins to transfer the heat energy in the extracted warm air from the roof cladding to the liquid medium flowing through the tube(s) and flowing to the heat pump unit allows a particularly efficient solution to be achieved.

The air-liquid heat exchanger, which is integrated in particular into the ridge and/or a cassette and/or the cavity, consists in particular of or is arranged in particular in an outer tube which can also be a collector tube and/or extension tube, e.g. the same or similar to the tube known from the prior art in the ridge for extracting the warm air from the roof membrane or as and/or in a cassette with air inlet and air outlet opening. This tubular heat exchanger can be integrated into the ridge, the cassette into the roof membrane and/or the cavity. The air-liquid heat exchanger can be integrated into the ridge or the roof. Alternatively, the air-liquid heat exchanger can, for example, be installed under or otherwise on the ridge and/or roof.

The air-liquid heat exchanger is advantageously formed by at least one tube, also a liquid transport tube, in particular a plurality of interconnected tubes, wherein the at least one tube, in particular the plurality of tubes, is/are preferably surrounded by metal fins, wherein the tubes are in particular arranged parallel to one another and/or are coupled to one another with elbows, wherein the fins of a tube have in their cross-section in particular an outer contour which is rectangular, square or hexagonal and in particular the fins of the parallel tubes in cross-section together form an outer contour which is rectangular and/or square and/or the fins of the parallel tubes in cross-section form a honeycomb structure, wherein the at least one tube and/or the parallel tubes and their fins are arranged in particular in the cavity or in a collector tube or cassette connected hydraulically thereto and in particular are arranged in the same longitudinal direction as the collector tube. Such embodiments increase the efficiency.

The fins, in particular those of neighboring tubes, can form together, in particular in plurality, with preferably at least 10 per tube, in particular straight air ducts for guiding the heated air. The air ducts are closed by the fins, in particular in four spatial directions. The longitudinal extension of the tubes and/or air ducts preferably runs in the direction of flow of the heated air, in particular when it flows from the cavity to the at least one outlet opening and/or through the heat exchanger and/or through the collecting device. The heated air is preferably guided accordingly. This increases the efficiency with a slight increase in air resistance.

In particular, the tubes are coupled and/or the process is controlled in such a way that the liquid in the liquid circuit flows through them; in particular, series and/or parallel connections of the tubes can be selected. In a particularly easy-to-implement embodiment, series connection of the tubes is preferred, in particular using elbows, which connect two, in particular adjacent ends, of tubes at one end. As a result, the liquid in the liquid circuit in the air-liquid heat exchanger then flows alternately in and opposite the direction of flow of the air in the tubes. In such a case, it is particularly preferable if the fins form thermal bridges between the tubes in order to prevent the temperature difference between the neighboring tubes from becoming too great.

The fins protrude in particular outwards from the tubes, in particular radially. In particular, they have a longitudinal extension parallel to the respective tube. A tube preferably has a number of fins in the range from 10 to 40. This creates a good balance between increased air resistance and heat transfer.

The parallel tubes are arranged parallel to each other, in particular viewed in cross-section perpendicular to the longitudinal extension of the tubes, preferably in at least two spatial directions, perpendicular to their longitudinal extension, with the directions in particular having an angle in the range of 45 to 135°. This enables a particularly compact and efficient design to be achieved.

Each of the tubes and/or the air-liquid heat exchanger has a tube length or length, in particular in the direction of flow of the heated air in the heat exchanger, in the range from 50 cm to 2 m. The air-liquid heat exchanger and/or the extension tube and/or collector tube has a diameter in the range from 1 cm to 1 m, preferably in the range from 10 cm to 50 cm and/or a number of parallel tubes in the range from 4 to 40, in particular 15 to 30. This creates a good balance between increased air resistance and heat transfer.

In particular, the cassette has a greater extension in two spatial directions than in a third spatial direction. In the third spatial direction, the cassette has in particular an extension in the range from 10 to 50 cm, in particular in the range from 15 to 40 cm. This extension or third spatial direction is in particular perpendicular to the outer end plane of the cavity and/or the plane of the, in particular, outer roof membrane. In particular, the cassette lies at least partially within the cavity, in particular it completely spans its height. In particular, the air-liquid heat exchanger, the ridge tube and/or the cassette is located outside the inner roof membrane and/or outside the interior of the building and/or outside the inner building shell.

In particular, the air-liquid heat exchanger, the ridge tube and/or the cassette does not completely penetrate the building shell.

Particularly advantageously, the cassette forms part of the outer building shell or is designed to do so. In particular, it has at least one air inlet opening on one, in particular lower and/or lateral, side extending in the third spatial direction and/or at least one air outlet opening on a side perpendicular or parallel thereto, in particular one of the largest and/or upper sides, and/or the side intended to form a part of the building shell or forming this part. The air outlet opening is designed in particular to be protected from rain. In particular, it is designed with an air guide channel such that the air is deflected by 130 to 270° and/or in the direction opposite to the direction of flow through at least one, in particular lower, air inlet opening and/or downwards after penetrating the side of the cassette. The embodiment can also be designed such that the air exits the cassette in the plane of the cavity and continues to flow through a short continuation of the cavity before being discharged at the ridge.

Depending on the embodiment, it may be advantageous to use only one air/water heat exchanger or to use several, for example in the collector tube, connected in series and/or cascaded. If several are used, it may be preferable to connect their liquid flow in series in the liquid circuit.

Advantageously, the at least one solar cell module has and/or forms inlet openings through which air can flow into the cavity and/or the system, in particular the collecting device, has at least one outlet opening through which air can escape from the cavity, the at least one outlet opening preferably being located higher than one and/or all the inlet openings and/or the air-liquid heat exchanger is arranged such that air that has entered the cavity through the inlet openings flows past the air-liquid heat exchanger before exiting through the outlet opening, said system being configured in particular such that the heating of the air in the cavity causes a thermal effect, and in which alternatively and/or additionally, at least one fan can also be provided which draws in air through the inlet openings and allows it to exit from the at least one outlet opening. The process is advantageously controlled accordingly.

Depending on the embodiment, it is preferable to provide at least one, in particular closable, in particular automatically closable, quick-ventilation opening, in particular at the end of the collecting device and/or opposite the outlet opening, to enable the air to escape without passing the air-liquid heat exchanger, in particular comprising a fan to convey the air out of the quick-ventilation opening. The process is advantageously controlled accordingly.

Depending on the embodiment, the inlet openings can preferably also be configured as a plurality of inlet openings on/in the surface and/or (additionally) in the lower area and/or at the lower end of the surface and/or the cavity. A plurality of inlet openings is preferably distributed essentially uniformly over the surface, in particular at a vertical and/or horizontal distance of less than 1 m, in particular less than 75 cm, from a neighboring opening, in particular from neighboring openings in four directions, unless they are at the edge. In particular, the inlet and outlet openings are protected from rain. In particular, inlet openings are formed at overlaps of solar cell modules, shingles and/or façade elements. In particular, solar cell modules, façade elements and/or shingles with intermediate rubber lips can be arranged overlapping one another and/or solar cell modules, shingles and/or façade elements with intermediate rubber lips can be arranged adjacent to one another and inlet openings can be created in the rubber lips by means of recesses. In addition, at least one, in particular larger, inlet opening can be arranged at the eaves or in the lower area and/or at the lower end of the cavity. The distributed inlet openings can achieve efficient cooling of the solar cell modules and increase thermal efficiency. In particular, the inlet openings distributed over the surface are each smaller than the at least one lower inlet opening and/or one or more inlet openings at the eaves.

In a particularly advantageous embodiment, the device has a defrosting device for defrosting the air-liquid heat exchanger and/or the process is controlled in such a way that the air-liquid heat exchanger is defrosted occasionally, i.e. from time to time, in particular when there is too much ice formation and/or after the temperature in the liquid circuit has dropped below certain temperatures for a certain period of time. For this, heating means, in particular electrical means, can be provided in and/or on the air-liquid heat exchanger and/or the collecting device and/or in the cavity and/or means can be provided to heat the liquid circuit. For example, heating and/or defrosting can also be carried out using the heat from the buffer storage tank and/or generated by the heat pump, and/or the system can be configured for this purpose.

Advantageously, the solar cell module has at least one transparent top layer, a solar cell and at least one dark, in particular black, or transparent bottom layer and/or these are, in particular in addition to contacts and their covering/insulation, the essential or all components. Advantageously, the solar cell module has a thickness in the range of 0.3 to 5 cm, in particular a thickness of less than 2 cm, in particular less than 1 cm, over at least 70% of its surface area. This makes it possible to achieve particularly good heating of the air in the cavity.

The at least one solar cell module is preferably part of a roof membrane, in particular an inclined roof membrane, in particular of its outer part, under which in particular wooden cladding, battens and/or underlay membrane are arranged, and/or the collecting device for air heated in the cavity is formed in particular above and/or at the level of the uppermost solar cell module, in particular as a ridge tube, and in particular the air/liquid heat exchanger is arranged, in particular in an end section of the collecting device and/or together with a fan, wherein the part of the collecting device comprising the air/liquid heat exchanger has in particular a condensation and/or defrost water drain device. Such an embodiment enables the particularly efficient, simple and/or large-scale utilization of the solar radiation.

The cavity is preferably formed between wooden cladding and/or underlay membrane on one side and the solar cell module on the other side and, in particular, is spanned by the roof battens. This enables a particularly simple and material-saving construction, in which the thermal mass of the at least one solar cell module can be kept low and/or the heat transfer from the solar cell into the cavity can be kept high.

In an alternative preferred embodiment, the at least one solar cell module is part of a screen wall, a fence and/or a façade. In such an embodiment, the solar cell module usually has a less inclined, sometimes even vertical orientation. This can be advantageous, however, when the sun is low, as is particularly the case in winter, for example, when a lot of heat is needed. The cavity can also be vertical in its orientation. A fan and/or baffle plate can also be arranged in the cavity. Depending on the embodiment, the air-liquid heat exchanger can, for example, be arranged vertically in the upper part of the cavity and/or apart from a lower part of the cavity, in the cavity, which is particularly preferred for comparatively short vertical lengths, in particular less than 3 m, in particular less than 2 m, or in or downline of a collecting device. For example, a top tube can be used, which is arranged in the upper part or above the cavity and leads to or contains the air-liquid heat exchanger; the same applies here in particular to the ridge tube.

The solar cell modules can, for example, form a curtain wall or be part of one. The cavity can then be limited, for example, by a wall made of wood, stone, concrete, plaster and/or insulating material on the side opposite the solar cell module. In this way, a cavity can be created to save material and large areas can be used easily. Installing the solar cell modules in front of an existing façade, for example one that is to be renovated or refurbished, also allows the building to be renovated with an additional protective layer and a new appearance by simply installing solar cell modules in front of it and thus creating a cavity.

Particularly if no collecting device is used and/or a cavity without an air outlet opening is used, it can be advantageous to install guide devices, in particular baffle plates, in the cavity in order to achieve a circulation of the air in the cavity. For this purpose, an arrangement is used in particular that causes a partial separation of the cavity into two vertical spaces and/or in such a way that air can rise directly behind the solar cell module and air can descend behind it, separated by the guide device.

Advantageously, the system can comprise a pump that is part of the liquid circuit and/or have a heat pump whose refrigerant circuit, in particular whose evaporator, is thermally coupled to the liquid circuit by means of the further heat exchanger, and/or the system can be configured and/or the process can be controlled in such a way that the heat pump and/or the pump are operated by electricity generated by the at least one solar cell module. In this way, the process/system can be designed to be particularly efficient and sustainable.

Particularly advantageously, the system comprises a pump that is part of the liquid circuit and/or a heat pump whose refrigerant circuit, in particular whose evaporator, is thermally coupled to the liquid circuit, and/or a buffer storage tank for storing heat and/or a fan for conveying heated air.

Particularly advantageously, the system has a control device, said control device being designed to control the pump and/or the heat pump and/or the process is managed to control the pump in such a way that the pump starts when the temperature of the heated air, the air-liquid heat exchanger and/or the liquid circuit exceeds a first predetermined temperature and/or stops and/or its delivery volume is reduced when the temperature of the heated air, the air-liquid heat exchanger and/or the liquid circuit falls below a second predetermined temperature.

The predetermined temperatures can also be defined in absolute terms or relative to variable temperatures, for example as a difference to another temperature, for example of the refrigerant circuit, the buffer storage tank and/or the inlet temperature. In particular, the first and second predetermined temperatures are similar, but are selected in such a way that a hysteresis is achieved and/or short cycle times between switching on and off are avoided as far as possible. In particular, the first predetermined temperature is higher than the second, in particular by a small, in particular single-digit, number of degrees, in particular in the range of 3 to 10° C.

Particularly advantageously, the system has a control device, said control device being designed to control the fan and/or the process is managed to control the fan in such a way that the fan starts and/or its delivery volume is increased when a third predetermined temperature of the heated air, of the air-liquid heat exchanger and/or a temperature difference between the heated air on the one side and the liquid circuit and/or the air-liquid heat exchanger on the other side is exceeded, and/or stops and/or its delivery volume is reduced when the temperature falls below a fourth predetermined temperature of the heated air, of the air-liquid heat exchanger and/or a temperature difference between the heated air on the one side and the liquid circuit and/or the air-liquid heat exchanger on the other side. In this way, the process can be controlled particularly efficiently and pump power can be saved, in particular without leaving heat unnecessarily unused.

The predetermined temperatures can also be defined in absolute terms or relative to variable temperatures, for example as a difference to another temperature, for example of the refrigerant circuit, the buffer storage tank and/or the inlet temperature. In particular, the third and fourth predetermined temperatures are similar, but are selected in such a way that a hysteresis is achieved and/or short cycle times between switching on and off are avoided as far as possible. In particular, the third predetermined temperature is higher than the fourth, in particular by a small number of degrees, in particular a single-digit number of degrees, in particular in the range of 3 to 10° C. In this way, overheating can be counteracted and/or the amount of heat transferred to the liquid circuit can be increased by starting and/or increasing the air flow through the fan.

Particularly advantageously, the system has a control device, said control device being designed to control the heat pump and/or the process is managed in such a way that the heat pump is started or its output is increased when either a fifth predetermined temperature in the buffer storage tank is undershot, with at least one sixth predetermined temperature of the heated air, the liquid circuit and/or the air-liquid heat exchanger being exceeded, or a seventh predetermined temperature, lower than the fifth, in the buffer storage tank is undershot, and that the heat pump is stopped and/or its output is reduced when either an eighth predetermined temperature in the buffer storage tank is exceeded, with at least one ninth predetermined temperature of the heated air, the liquid circuit and/or the air-liquid heat exchanger not being exceeded, or a tenth predetermined temperature in the buffer storage tank is exceeded.

The predetermined temperatures can also be defined in absolute terms or relative to variable temperatures, for example as a difference to another temperature, for example of the refrigerant circuit, the buffer storage tank and/or the inlet temperature. In particular, the fifth and tenth and the seventh and eighth predetermined temperatures respectively are similar, but are selected in particular in such a way that a hysteresis is achieved and/or short cycle times between switching on and off are avoided as far as possible. In particular the eighth predetermined temperature is higher than the seventh and/or the tenth is higher than the fifth, in particular by a small number of degrees, in particular a single-digit number of degrees, in particular in the range of 3 to 10° C. In particular the tenth predetermined temperature is higher than the eighth and the fifth higher than the seventh and/or the sixth is identical to or higher than the ninth.

In this way, it is possible to achieve a higher temperature (fifth predetermined temperature), for example in the buffer storage tank, when there is sufficient heat (above the sixth predetermined temperature) in the liquid circuit, the air-liquid heat exchanger and/or the cavity than when there is insufficient heat (sixth temperature or lower) in the liquid circuit, of the air-liquid heat exchanger and/or in the cavity, but nevertheless a sufficient temperature (seventh predetermined temperature) is maintained, for example in the buffer storage tank, even if there is insufficient heat in the liquid circuit, the air-liquid heat exchanger and/or in the cavity. This enables particularly efficient operation.

The sixth temperature can, for example, be fixed or predetermined depending on the difference between the fifth and/or seventh temperature and the current temperature in the buffer storage tank.

Advantageously, the system has at least one temperature sensor on/in the collecting device, the liquid circuit and/or on the air-liquid heat exchanger and/or the process involves continuous and/or repetitive measurement of the temperature in the collecting device and/or on/in the liquid circuit and/or the air-liquid heat exchanger.

The objective is also solved by an air-liquid heat exchanger formed by at least one tube for guiding liquid through the air-liquid heat exchanger for the purpose of heating the liquid in which the at least one tube is surrounded by metal fins connected to the at least one tube and in which the tubes are arranged parallel to each other and are hydraulically coupled to each other for guiding liquid through the air-liquid heat exchanger, and in which the tube and the fins are arranged in an extension or collector tube with the same direction of longitudinal extension as the extension or collector tube or in a cassette which has at least one air inlet opening for fastening to or arrangement in a cavity that is heated by solar radiation and at least one air outlet opening that is arranged in particular such that the air outlet takes place in a different plane than the air inlet.

The object is also achieved by a system for reducing the heating of a building, which is preferably part of the system described above, said building having a roof and/or a façade comprising a plurality of, in particular overlapping, covering elements, in particular shingles, and an air-filled cavity located behind them, in particular delimited by an underlay membrane or building wall, wherein the system comprises at least one fan designed to extract air from the cavity, characterized in that air inlet openings into the cavity are provided in at least 30% of the covering elements and/or between a plurality of pairs of the covering elements, said plurality corresponding to at least 30% of the number of covering elements, which are distributed in particular over the vertical extent of the roof or façade.

The object is also achieved by a process which is preferably part of the process described above, for reducing the heating of a building, in particular its interior, by solar radiation, said building having a roof and/or a façade comprising a plurality of, in particular overlapping and/or adjoining, covering elements, in particular shingles, and an air-filled cavity located behind them, in particular delimited by wooden cladding, an underlay membrane and/or building wall, with air being extracted from of the cavity by means of a fan, characterized in that air inlet openings into the cavity are provided in at least 30% of the covering elements and/or between a plurality of pairs of the covering elements, said plurality corresponding to at least 30% of the number of covering elements, which are distributed in particular over the vertical extent of the roof or façade.

The covering elements preferably have solar cell modules and/or are made of such modules. With regard to the air inlet openings, the same applies in particular to the inlet openings and vice versa.

### BRIEF DESCRIPTION OF THE DRAWINGS

Further advantages and embodiments are explained below purely by way of example and not by way of limitation with reference to the following purely schematic figures. Here:

FIG. 1a shows a schematic representation of a roof, FIG. 1b shows a schematic representation of a roof,

FIG. 2 shows a section through a roof with the inventive system,

FIGS. 3-5 show sections through a heat exchanger and a collector tube,

FIGS. 6-8 show details of a heat exchanger, and

FIG. 9 shows a cross-section through a screen wall element, and

FIG. 10 shows a cross-section through a screen wall element, and

FIG. 11 shows a longitudinal section through the screen wall element in FIG. 10, and

FIG. 12 shows a cross-section through a house with roof with cassette.

### DETAILED DESCRIPTION

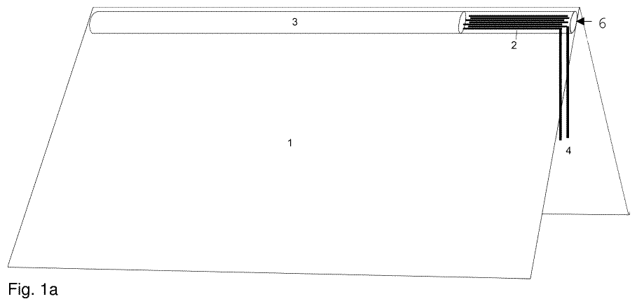

FIG. 1a shows a roof 1 with a ridge tube 3 and an air-liquid heat exchanger 2 arranged in the ridge tube and an opening in the end of the ridge tube that is not shown in the area of the heat exchanger, and a part of the liquid circuit 4 to which the air-liquid heat exchanger 2 belongs.

FIG. 1b shows this roof 1, illustrating other aspects. Solar cell modules 13 designed as solar shingles and the resulting cavity 14 in the area of the roof battens can be seen. Air inlet openings 6 are provided at the eaves with a ridge tube 3 and an air-liquid heat exchanger arranged therein, not illustrated, as well as an opening in the end of the ridge tube. The air escaping here is illustrated by an arrow pointing upwards. Also illustrated are the air inlet openings between the solar shingles, marked by small arrows that indicate the air inlet.

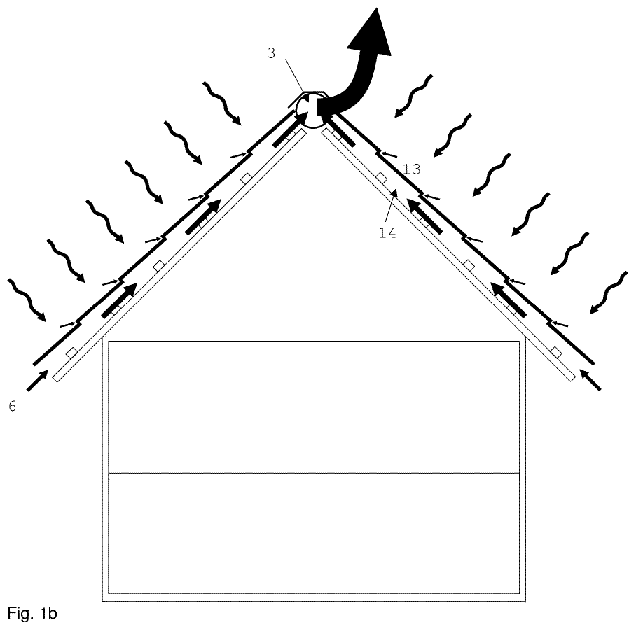

This arrangement is also shown in FIG. 2 in which, however, the air-liquid heat exchanger is again not illustrated. The cavity 14 created under the solar cell modules 13 designed as solar shingles can be seen in the area of the roof battens. Air inlet openings 6 are provided at the eaves.

The solar radiation heats the air in the cavity, which rises thermally and/or driven by a fan in the ridge tube and, collected in the collector tube 3 in the ridge, is conducted past the air-liquid heat exchanger and thus heats the liquid in the liquid circuit 4. The liquid circuit 4 transports the heat to the heat pump 5 by means of a pump.

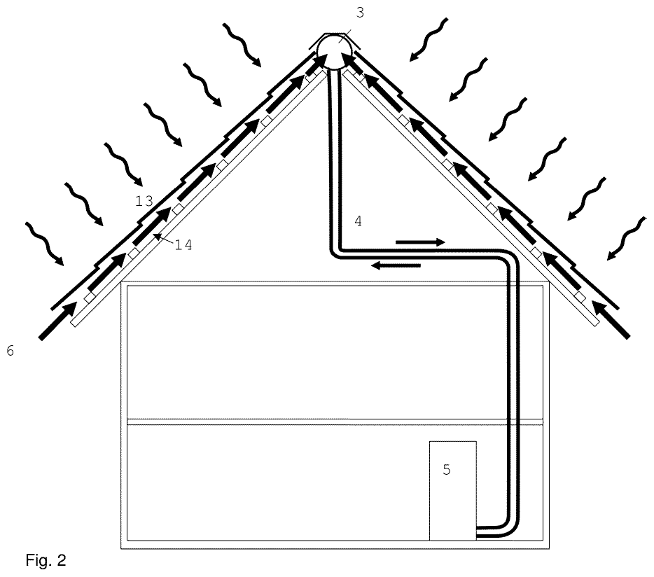

FIGS. 3 to 5 each shows details of a cross-section of an air-liquid heat exchanger. Tubes 8 of the liquid circuit can be seen that are part of the air-liquid heat exchanger. These are arranged parallel to each other in two directions and each have radially or approximately radially extending fins 9. The heated air flows past these and can transfer some of its thermal energy to the liquid via the fins and the tube. The fins of adjacent tubes form air ducts and create thermal bridges between the tubes. The tubes with their fins are arranged and designed in such a way that they largely fill a collector tube 7 that surrounds them. The heated air flows through the collector tube. The tubes and air ducts are arranged in the direction of flow so that the air can flow past as large an area as possible with as little resistance as possible and release thermal energy.

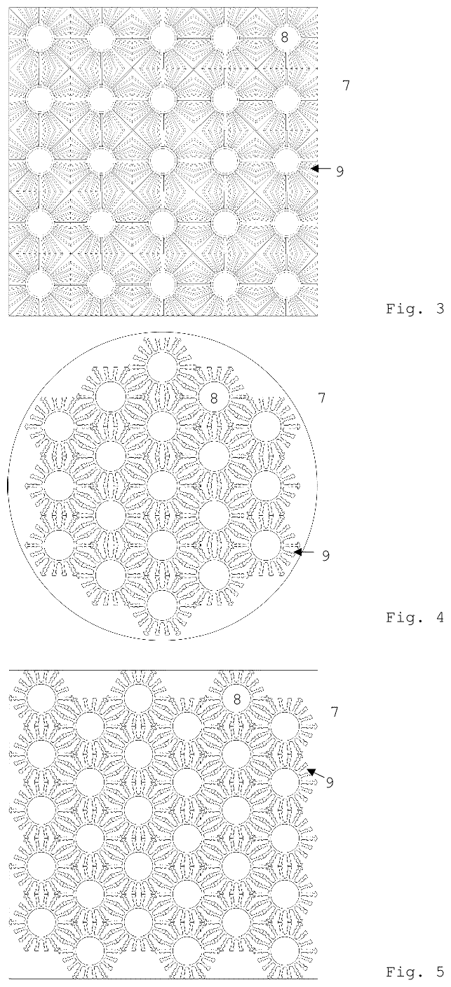

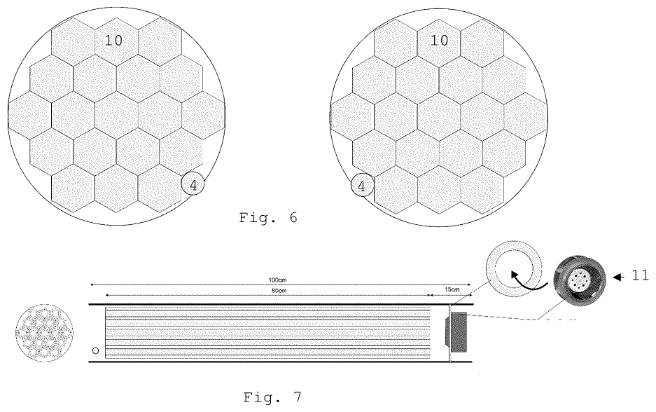

It can also be seen that the fins of each tube in FIG. 3 have a square outer contour, while in FIGS. 4 and 5 hexagonal fin arrangements can be seen in cross-section, each around one tube. Together they form a honeycomb structure.

FIG. 6 shows a particularly schematic representation of such a honeycomb-like arrangement of tubes with fins 10 in a collector tube from both ends. Inlets and outlets can also be seen that are part of the liquid circuit 4.

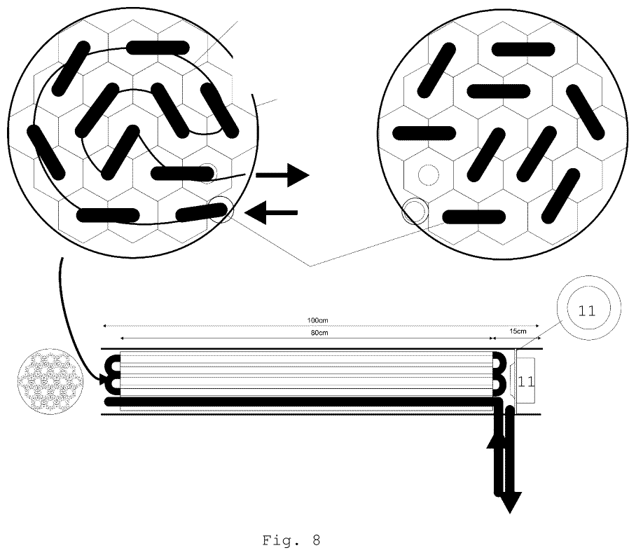

FIG. 7 shows an air heat exchanger in a collector tube with a fan 11. A cross-section as in FIG. 4 is shown on the left; in the middle a longitudinal section through the collector tube can be seen with the heat exchanger arranged in it and a fan to the right. This is shown again on the right.

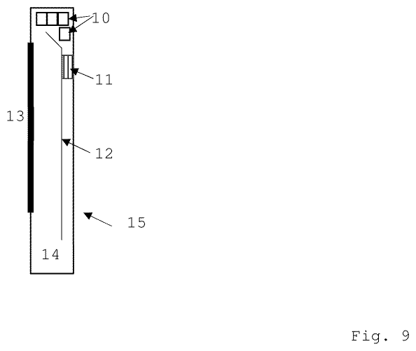

FIG. 8 illustrates one way of routing the liquid through the heat exchanger. The connection of the parallel tubes is shown at the top left of the left end face and at the top right of the right end face. In the top left illustration, it can be seen that a feed tube (bottom right and without fins) first guides the liquid into the plane of the end face and then transfers it to a first tube of the heat exchanger. The water is then diverted again through an elbow on the other right-hand end face (shown in bold) and is fed through another tube of the heat exchanger to the left-hand end face and so on. In the projection onto the left-hand end face, the routing of the water is shown roughly by a thin line. The arrows illustrate the inlet and discharge of the liquid and the lower sectional view also shows the fan 11 arranged to the right of the right end face, which draws in air from the left and discharges it to the right, for example through the air outlet opening.

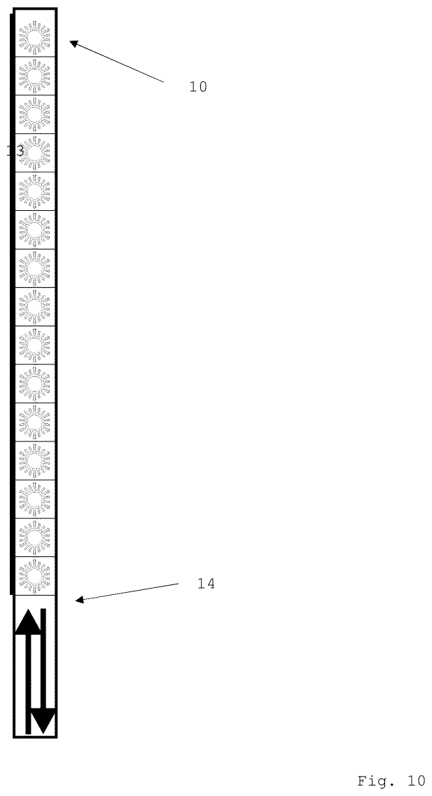

FIG. 9 shows a cross-section of a façade element. A cavity 14 can be seen behind a solar cell module 13. An air-liquid heat exchanger with tubes and fins 10 is shown in the upper part of the cavity. An baffle plate 12 and a fan 11 can also be seen. Solar radiation onto the left surface which includes the solar cell module heats the air in the cavity 14 and causes the air to rise. The air cools down at the air-liquid heat exchanger and falls back down again. The baffle plate 12 reduces the mixing of warmer and cooled air. The fan 11 can further strengthen the flow.

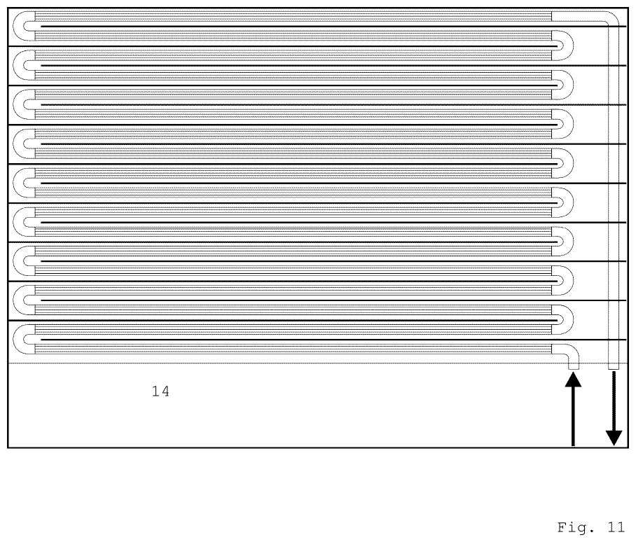

FIG. 10 shows a different embodiment of a façade element in cross-section. A cavity 14 can be seen behind a solar cell module 13. An air-liquid heat exchanger with tubes and fins 10 is shown in the cavity apart from in the lower part. Solar radiation onto the left surface which includes the solar cell module heats the air in the cavity 14 and causes the air to rise. The air cools down at the air-liquid heat exchanger and falls back down again. The inlet and discharge of the liquid are indicated by arrows.

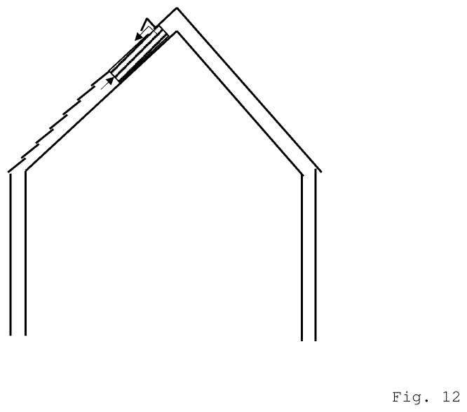

FIG. 11 shows a longitudinal section through the façade element in FIG. 10. The routing of the liquid through the heat exchanger can be seen.

FIG. 12 shows a cross-section through a house with an inner and outer building shell, whereby the outer building shell on the left-hand side in the area of the lower roof is formed by overlapping solar tiles with air inlet gaps between them and in the section above, a cassette with an air-liquid heat exchanger inside is arranged so that it forms part of the outer building shell, in this case the outer roof membrane, but is itself outside the inner building shell. The cassette (hatched) has an air inlet opening in the lower area (indicated by an arrow). An air outlet opening is arranged on the side that also forms the roof membrane, which has an baffle plate to form an air duct and deflect the escaping air (also indicated by an arrow). Only the tubes (not illustrated) for the liquid circuit flowing through the heat exchanger penetrate the inner roof membrane here.

### LIST OF REFERENCE SYMBOLS

1 Roof
2 Air-to-liquid heat exchanger
3 Ridge tube
4 Liquid circuit
5 Heat pump
6 Inlet opening
7. Collector tube
8 Tube
9 Fin
10 Tube with fins
11 Fan
12 Baffle plate
13 Solar cell module
14 Cavity
15 Screen wall element

1. A system for generating electricity and heat by means of solar radiation in which at least one solar cell module together with at least one further element forms a cavity on a rear side of the at least one solar cell module, said cavity being filled with air, with said system being configured such that solar radiation incident on the at least one solar cell module heats the air in the cavity, said system also being configured to bring the air heated in the cavity into contact with an air-liquid heat exchanger, with said air-liquid heat exchanger being located in a ridge of a roof or in an upper part of the air-filled cavity designed for heating by solar radiation, said air-liquid heat exchanger being part of a water line and being configured or arranged to heat water in the water line, said water line being configured to supply heated drinking or service water to a tapping point or said air-liquid heat exchanger being part of a liquid circuit, said liquid circuit being configured or arranged to heat a refrigerant circuit or to heat an evaporator or to heat a buffer storage tank or pool.

2. The system according to claim 1 in which the liquid circuit is a liquid circuit without a compressor or the liquid circuit is not a refrigerant circuit or the liquid circuit is a liquid circuit without an expansion device, or in which the liquid of the liquid circuit has a boiling point above 50° C. at standard conditions or the liquid circuit is a liquid circuit with a pressure below 3 bar or the liquid includes anti-freeze or the liquid circuit is a liquid circuit which, apart from a pump arranged therein, has a cross-sectional variation of less than 20% of a maximum cross-section or the liquid circuit is a liquid circuit with a constant cross-section or the liquid circuit is a liquid circuit with a pump or the liquid comprises water and additives.

3. The system according to claim 1 wherein a collecting device for air from the cavity is arranged in or above the cavity and the collecting device is configured to supply the collected air to the air-liquid heat exchanger or a fan is provided that is configured and arranged to supply heated or collected air to the air-liquid heat exchanger.

4. The system according to claim 1 wherein a further heat exchanger of the liquid circuit is also part of a water or refrigerant circuit of a heat pump.

5. The system according to claim 3 wherein a further heat exchanger of the liquid circuit is also part of a water or refrigerant circuit of a heat pump, said system being configured to supply heat generated by the heat pump to a buffer storage tank or a further buffer storage tank.

6. The system according to claim 1 wherein the air-liquid heat exchanger is formed by at least one tube, said at least one tube being surrounded by fins made of metal, and in which the at least one tube and its fins are arranged in the cavity or in a collector tube connected hydraulically to the cavity or in a cassette connected hydraulically to the cavity.

7. The system according to claim 1 wherein the at least one solar cell module has or forms inlet openings through which air can flow into the cavity, or the system has at least one outlet opening through which air can escape from the cavity, the at least one outlet opening being located higher than one or all the inlet openings or the air-liquid heat exchanger is arranged such that air that has entered the cavity through the inlet openings flows past the air-liquid heat exchanger before exiting through the at least one outlet opening, said system being configured such that the heating of the air in the cavity causes a thermal effect which draws in air through the inlet openings and allows the air to exit from the at least one outlet opening.

8. The system according to claim 1 having at least one closable quick-ventilation opening to enable the air to escape from the cavity without passing the air-liquid heat exchanger.

9. The system according to claim 8 having a fan to convey the air out of the quick-ventilation opening.

10. The system according to claim 1 in which the solar cell module has at least one transparent top layer, a solar cell and at least one colored or transparent bottom layer or a thickness in the range from 0.3 to 5 cm.

11. The system according to claim 1 in which the at least one solar cell module is part of a roof membrane, and a collecting device for air heated in the cavity is formed above or at a level of an uppermost solar cell module.

12. The system according to claim 1 in which the air-liquid heat exchanger is arranged in a collecting device together with a fan or wherein a part of the collecting device comprising the air-liquid heat exchanger comprises a condensation or defrost water drain device.

13. The system according to claim 1 in which the cavity is formed between wooden cladding or underlay membrane and the solar cell module and is spanned by roof battens.

14. The system according to claim 1 in which the system has a pump that is part of the liquid circuit or has a heat pump whose refrigerant circuit is thermally coupled to the liquid circuit by means of the further heat exchanger, and the system is configured to operate the heat pump or the pump using the electricity generated by the at least one solar cell module.

15. The system according to claim 1 having a control device, said system having a pump that is part of the liquid circuit or a heat pump whose refrigerant circuit is thermally coupled to the liquid circuit, said control device being configured to control the pump or the heat pump in such a way that the pump starts when a first predetermined temperature of the heated air, the air-liquid heat exchanger or the liquid circuit is exceeded or stops when the temperature of the heated air, the air-liquid heat exchanger or the liquid circuit falls below a second predetermined temperature.

16. The system according to claim 1 having a control device and a fan, said control device being designed to control the fan in such a way that the fan starts when a third predetermined temperature of the heated air, of the air-liquid heat exchanger or a temperature difference between the heated air on the one side and the liquid circuit or the air-liquid heat exchanger on the other side is exceeded, and stops when the temperature falls below a fourth predetermined temperature of the heated air of the air-liquid heat exchanger or a temperature difference between the heated air on one side and the liquid circuit or the air-liquid heat exchanger on the other side.

17. The system according to claim 1 having a control device and a heat pump whose refrigerant circuit is thermally coupled to the liquid circuit, and a buffer storage tank, said control device being designed to start the heat pump when either a fifth predetermined temperature in the buffer storage tank is undershot, with a sixth predetermined temperature of the heated air, the liquid circuit or the air-liquid heat exchanger being exceeded, or a seventh predetermined temperature, lower than the fifth, in the buffer storage tank is undershot, and to stop the heat pump when either an eighth predetermined temperature in the buffer storage tank is exceeded, with a ninth predetermined temperature of the heated air, the liquid circuit or the air-liquid heat exchanger not being exceeded, or a tenth predetermined temperature in the buffer storage tank is exceeded.

18. The system according to claim 1 further comprising at least one temperature sensor in the collecting device or on the air-liquid heat exchanger.

19. An air-liquid heat exchanger formed by at least one tube for guiding liquid through the air-liquid heat exchanger for the purpose of heating the liquid in which the at least one tube is surrounded by metal fins connected to the at least one tube and in which the tubes are arranged parallel to each other and are hydraulically coupled to each other for guiding liquid through the air-liquid heat exchanger, and in which the tube and the fins are arranged in an extension or collector tube with the same direction of longitudinal extension as an extension or collector tube or in a cassette which has at least one air inlet opening for fastening to or arrangement in a cavity that is heated by solar radiation and at least one air outlet opening is arranged to allow the air to exit.

20. A process for co-generation of electricity and heated liquid by solar radiation on a surface by means of at least one solar cell module forming the surface and heating of air below the solar cell module by the solar radiation on the surface and transfer of the thermal energy stored in the air at least partially into a liquid circuit filled with liquid or a water line filled with water by means of an air-liquid heat exchanger.
